(19) United States
(12) Patent Application Publication
(10) Pub. No.: US 2015/0270577 A1
(43) Pub. Date: Sep. 24, 2015

(54) LITHIUM SECONDARY BATTERY

(71) Applicant: Panasonic Intellectual Property Management Co., Ltd., Osaka (JP)

(72) Inventor: Hideharu Takezawa, Nara (JP)

(21) Appl. No.: 14/441,339

(22) PCT Filed: Dec. 26, 2013
(86) PCT No.: PCT/JP2013/007636

§ 371 Date: May 7, 2015

(30) Foreign Application Priority Data
Jan. 15, 2013 (JP) 2013-004757

(51) Int. Cl. H01M 10/0569; H01M 4/38; H01M 4/56; H01M 4/525; H01M 4/505; H01M 10/052; H01M 10/0567

(52) U.S. Cl. CPC H01M 10/0569; H01M 10/052; H01M 4/386; H01M 10/0567; H01M 4/525; H01M 4/505; H01M 4/56; H01M 2300/0034; H01M 2300/0037; H01M 2220/20; H01M 2220/30

(57) ABSTRACT

A lithium secondary battery includes: a positive electrode including Li—CoₘM₁₋ₘOₙ (M represents at least one element selected from the group consisting of Na, Mg, Sc, Y, Mn, Fe, Co, Ni, Cu, Zn, Al, Cr, Pb, Sb and B, where 0≦x≦1.2, 0.9≦m≦1.0, 2.0≦n≦2.3); a negative electrode capable of absorbing/desorbing lithium; a separator arranged between the positive electrode and the negative electrode; and a nonaqueous electrolyte solution including fluoroethylene carbonate, a carbonate other than fluoroethylene carbonate, a compound having an isocyanate group, and lithium difluorophosphate.

### TECHNICAL FIELD

The present application relates to lithium secondary batteries.

### BACKGROUND ART

Lithium secondary batteries have a high capacity and a high energy density, and it is easy to reduce the size and the weight thereof. Therefore, they have been widely used as power supplies for portable small electronic devices, such as mobile telephones, personal digital assistants (PDAs), notebook-type personal computers, video cameras, portable game devices, etc. In recent years, for portable small electronic devices, there has been a demand for further increasing the functionalities thereof and for extending the length of time over which they can be used continuously. Lithium secondary batteries are expected to be used not only as power supplies for small electronic devices, but also as power supplies for large devices such as hybrid cars, electric vehicles, electric tools, etc. In order to meet these demands, it is necessary to further increase the capacity of lithium secondary batteries used as power supplies.

Two possible methods for further increasing the capacity of lithium secondary batteries are:

Method (A) of increasing the range over which the positive electrode is used, and

Method (B) of increasing the capacity of the negative electrode.

Method (A) uses an approach of increasing the charging voltage and to expand the potential range available. In this case, it is possible that the nonaqueous electrolyte solution may come into contact with the positive electrode at a high potential, thereby causing oxidative degradation. Therefore, an attempt has been made to use a mixed solvent of adiponitrile (AdpCN) and fluoroethylene carbonate (FEC) (Patent Document No. 1), and an attempt has been made to increase the voltage by combining FEC, diethyl carbonate (DEC) and sulfone compound with a positive electrode containing zirconium (Patent Document No. 2). However, as shown in FIG. 5 of Non-Patent Document No. 1, it is known that where ethylene carbonate and dimethyl carbonate are used as the solvent, if the positive electrode is brought to a high potential, cobalt elutes from the positive electrode.

Known high-capacity negative electrode active materials of Method (B) include silicon, tin, an oxide thereof, a nitride thereof, a compound containing the same, an alloy containing the same, etc. Since these negative electrode active materials have substantial expansion/shrinking due to insertion/desorption of lithium while charging/discharging, the active material cracks to expose an active newly-formed surface, and the negative electrode active material is oxidized and inactivated through reaction with an electrolyte solution component occurring at the newly-formed surface. Moreover, as gaps are produced where cracks have been made, the negative electrode active material is made porous, thereby excessively increasing the volume of the negative electrode active material. As a result, the charge-discharge cycle characteristic deteriorates and, in addition, the thickness of the negative electrode increases, thereby swelling the battery.

For these problems, Patent Document No. 3 discloses that it is possible to suppress the charge-discharge cycle characteristic and the increase in the thickness of the negative electrode after passage of a cycle, by using silicon as the negative electrode active material and adding FEC to the electrolyte solution. Patent Document No. 3 states that FEC forms a suitable coating on the surface of the negative electrode active material, thereby suppressing the reaction between the negative electrode active material and the nonaqueous electrolyte solution, and suppressing the expansion due to the deterioration of the negative electrode active material.

Moreover, an attempt has been made to add an isocyanate compound in addition to FEC in order to improve the lifetime of the negative electrode using silicon (Patent Document No. 4).

### CITATION LIST

### Patent Literature

[Patent Document No. 1] Japanese Laid-Open Patent Publication No. 2009-158240
[Patent Document No. 2] Japanese Laid-Open Patent Publication No. 2011-192402
[Patent Document No. 3] Japanese Laid-Open Patent Publication No. 2006-86058
[Patent Document No. 4] International Publication WO2010/021236

### NON-PATENT LITERATURE

[Non-Patent Document No. 1] Solid State Ionics 83 (1996) 171 FIG. 5

### SUMMARY OF INVENTION

### Technical Problem

With conventional lithium secondary batteries described above, other problems may arise as the capacity is increased. A non-limiting example embodiment of the present application provides a lithium secondary battery having a desirable battery performance and a high capacity.

### Solution to Problem

A lithium secondary battery according to one aspect of the present invention includes: a positive electrode including LiₓCoₘM₁₋ₘOₙ (M represents at least one element selected from the group consisting of Na, Mg, Sc, Y, Mn, Fe, Co, Ni, Cu, Zn, Al, Cr, Pb, Sb and B, where 0≦x≦1.2, 0.9≦m≦1.0, 2.0≦n≦2.3); a negative electrode capable of absorbing/desorbing lithium; a separator arranged between the positive electrode and the negative electrode; and a nonaqueous electrolyte solution including fluoroethylene carbonate, a carbonate other than fluoroethylene carbonate, a compound having an isocyanate group, and lithium difluorophosphate.

### Advantageous Effects of Invention

With the lithium secondary battery according to one aspect of the present invention, it is possible to achieve a high capacity and to suppress the battery swelling after storage at a high temperature, thereby improving the reliability.

### BRIEF DESCRIPTION OF DRAWINGS

FIG. 1 A cross-sectional view showing an example of a configuration of an embodiment of a lithium secondary battery according to the present invention.

FIG. 2 A cross-sectional view showing another example of a configuration of an embodiment of a lithium secondary battery according to the present invention.

FIG. 3 A perspective view showing an example of a negative electrode current collector according to an embodiment.

FIG. 4 A cross-sectional view showing an example of a columnar active material assembly of a negative electrode active material layer according to an embodiment.

FIG. 5 A diagram showing a vapor deposition apparatus that can be used for producing a negative electrode of an embodiment.

FIG. 6 A graph showing charging/discharging curves of an example and comparative examples.

### DESCRIPTION OF EMBODIMENTS

The present inventor found that with a lithium secondary battery using a transition metal oxide as the positive electrode and FEC as the electrolyte solution, if the battery voltage is set to 4.3 V (vs. Li) or higher in order to increase the capacity, the amount of elution of the positive electrode, particularly cobalt, increases, thereby deteriorating the characteristics during storage at a high temperature. When cobalt elutes from the positive electrode, cobalt is reduced to deposit on the negative electrode, and FEC degrades thereon, forming a high-resistance coating. As a result, the polarization characteristic deteriorates, and lithium deposits, to cause micro short-circuit through the separator and disturb the crystalline structure of the positive electrode surface, thereby deteriorating the restoration characteristic after storage.

Situations where a positive electrode using lithium cobalt oxide is used up to a high potential include cases where a silicon-based material or a tin-based material is used, which have a high capacity and with which the operating potential of the negative electrode is higher than that of graphite or metal lithium. For example, a conventional battery using graphite (operating potential: 20 to 50 mV) as the negative electrode, and using lithium cobalt oxide as the positive electrode, is often used in the range of 3 to 4.2 V. In this case, the operating potential of the lithium cobalt oxide of the positive electrode is 4.25 V at maximum. In contrast, where a silicon-based material is used as the negative electrode, the operating potential is about 100 to 200 mV and is higher than that of graphite. Therefore, with the operating potential of the battery being equal to that in the case of graphite, the range in which lithium cobalt oxide is used is 4.45 V at maximum. That is, the positive electrode will be brought to a high potential as a result of using the positive electrode in a range where the utilization ratio is high so as to increase the capacity of the positive electrode in order to make use of the high capacity of the negative electrode.

In view of such a problem, the present inventor has arrived at a novel lithium secondary battery. An outline of one aspect of the present invention is as follows.

A lithium secondary battery according to one aspect of the present invention includes: a positive electrode including Li—CoₘM₁₋ₘOₙ (M represents at least one element selected from the group consisting of Na, Mg, Sc, Y, Mn, Fe, Co, Ni, Cu, Zn, Al, Cr, Pb, Sb and B, where 0≦x≦1.2, 0.9≦m≦1.0, 2.0≦n≦2.3); a negative electrode capable of absorbing/desorbing lithium; a separator arranged between the positive electrode and the negative electrode; and a nonaqueous electrolyte solution including fluoroethylene carbonate, a carbonate other than fluoroethylene carbonate, a compound having an isocyanate group, and lithium difluorophosphate.

The positive electrode may be charged with a potential of 4.3 V or more with respect to metal lithium.

The nonaqueous electrolyte solution may include: ethylene carbonate; at least one selected from the group consisting of propylene carbonate, dimethyl carbonate, diethyl carbonate and methyl ethyl carbonate; and at least one selected from the group consisting of lithium hexafluorophosphate, lithium tetrafluoroborate, bistrifluoromethanesulfonylimide lithium, bis(perfluoroethyl sulfonyl)imide lithium and lithium bis(oxalato)borate.

The compound having an isocyanate group may be hexamethylene diisocyanate.

The nonaqueous electrolyte solution may further include a compound having a nitrile group.

The compound having a nitrile group may be adiponitrile.

The negative electrode may include at least one of silicon and a silicon alloy.

The silicon and the silicon alloy may include a silicon oxide represented as SiO_{α} (0≦α≦2.0).

The negative electrode may have a negative electrode current collector, and a negative electrode active material layer formed on the negative electrode current collector; the negative electrode active material layer may include a plurality of active material assemblies arranged on a surface of the negative electrode current collector; each of the plurality of active material assemblies may have a plurality of layers stacked together; and directions in which the plurality of layers grow may be alternately inclined in opposite directions with respect to a normal direction to the negative electrode current collector.

The negative electrode may not substantially include a binder and a conductive agent.

A lithium secondary battery according to another aspect of the present invention includes: lithium cobalt oxide charged with a potential of 4.3 V or more with respect to metal lithium, in a positive electrode; silicon and/or a silicon alloy, in a negative electrode capable of absorbing/desorbing lithium; a separator interposed between the positive electrode and the negative electrode; and hexamethylene diisocyanate and lithium difluorophosphate, in a nonaqueous electrolyte solution including fluoroethylene carbonate.

As an embodiment of the present invention, an embodiment of a lithium secondary battery according to the present invention will now be described with reference to the drawings.

<Configuration of Lithium Secondary Battery>

FIG. 1 is a cross-sectional view schematically showing a configuration of a lithium secondary battery of the present embodiment.

A lithium secondary battery 200 includes a positive electrode 30, a negative electrode 20, a separator 13 arranged between the positive electrode 30 and the negative electrode 20, and a nonaqueous electrolyte solution 35.

For example, the positive electrode 30 includes a positive electrode current collector 31 and a positive electrode active material layer 33, and is capable of absorbing/desorbing lithium.

For example, the negative electrode 20 includes a negative electrode current collector 21 and a negative electrode active material layer 23, and is capable of absorbing/desorbing lithium. A positive electrode lead 18, a negative electrode lead 19, a gasket 16 and an external casing 17 are further arranged in the battery shown in FIG. 1. The positive electrode lead 18 is connected to the positive electrode current collector 31, and the negative electrode lead 19 is connected to the negative electrode current collector 21. The group of electrodes, composed of the positive electrode 30, the negative electrode 20 and the separator 13, is sealed in the external casing 17, together with the nonaqueous electrolyte solution 35.

Although FIG. 1 shows a group of electrodes including one positive electrode 30 and one negative electrode 20 stacked together with the separator 13 therebetween, a lithium secondary battery of the present embodiment may include another form of a group of electrodes.

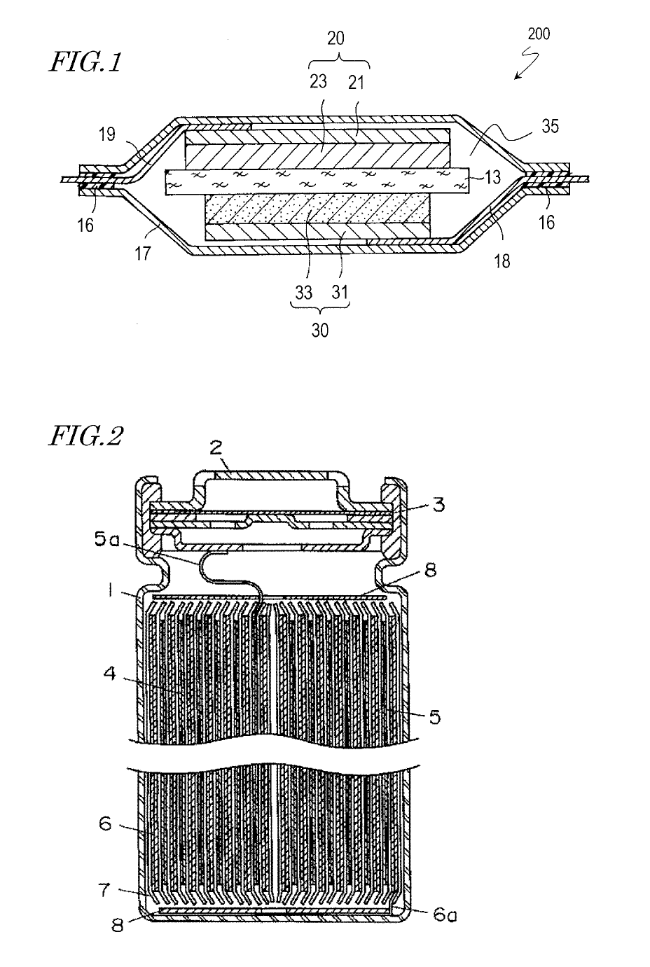

FIG. 2 is a schematic cross-sectional view showing another example of a lithium secondary battery of the present embodiment.

The lithium secondary battery includes a battery casing 1, a group of electrodes 4 housed in the battery casing 1, and insulation rings 8 arranged over and under the group of electrodes 4. The battery casing 1 has an opening on top, and the opening is sealed with a sealing plate 2.

The group of electrodes 4 has a configuration where a positive electrode 5 and a negative electrode 6 are rolled up spirally a plurality of times with a separator 7 therebetween. A positive electrode lead 5a made of aluminum, for example, is extended from the positive electrode 5, and a negative electrode lead 6a made of copper, for example, is extended from the negative electrode 6. The positive electrode lead 5a is connected to the sealing plate 2 of the battery casing 1. The negative electrode lead 6a is connected to the bottom portion of the battery casing 1. Although not shown in the figures, inside the battery casing 1, an electrolyte solution is injected, together with the group of electrodes 4.

The detailed configuration of each component will now be described.

<Configuration and Production Method of Positive Electrode 30>

The positive electrode current collector 31 may be any of those that are commonly used in this field of art. For example, it may be a porous or non-porous conductive substrate made of a metal material, such as stainless steel, titanium or aluminum, or a conductive resin. A porous conductive substrate may be, for example, a mesh material, a net material, a punching sheet, a lath material, a porous material, a foamed material, a fiber aggregate molded material (such as a nonwoven fabric), etc. A non-porous conductive substrate may be, for example, a foil, sheet, a film, etc. While there is no particular limitation on the thickness of the porous or non-porous conductive substrate, it is for example 1 μm to 500 μm, preferably 1 μm to 50 μm, more preferably 10 μm to 40 μm, and particularly preferably 10 to 30 μm.

The positive electrode active material layer 33 includes a positive electrode active material. It may also include a conductive agent and a binder, as necessary.

The positive electrode active material may be a LiₓCoO₂ or a metal oxide obtained by substituting a part of Co with a different element. The different element, as used herein, may be at least one element selected from the group consisting of Na, Mg, Sc, Y, Mn, Fe, Co, Ni, Cu, Zn, Al, Cr, Pb, Sb and B. When Mn, Al, Ni or Mg is used, from among those listed above, there is an advantage that the crystal lattice of the base material becomes stable, and it is possible to achieve a high utilization ratio of the active material. The different element may be one element or two or more elements. Specific examples of the lithium-containing composite metal oxide include, for example, LiₓCoO₂ and LiₓCoₘM₁₋ₘOₙ (where M represents at least one element selected from the group consisting of Na, Mg, Sc, Y, Mn, Fe, Co, Ni, Cu, Zn, Al, Cr, Pb, Sb and B, and x, m and n satisfy 0≦x≦1.2, 0.9≦m≦1.0 and 2.0≦n≦2.3). Although the molar ratio of lithium may increase or decrease through charging/discharging, the value m herein is the value immediately after the production of the positive electrode active material.

A lithium-containing composite metal oxide may be manufactured by a known method. For example, lithium cobalt oxide (LiCoO₂) may be manufactured by a solid-phase reaction method as follows. It can be obtained by mixing lithium carbonate (Li₂CO₃) and cobalt oxide (Co₃O₄) together at a molar ratio of 3:2, and baking it in the air at a temperature of 600° C. to 950° C.

LiₓCoO₂ in which a part of the cobalt element is substituted, i.e., LiₓCoₘM₁₋ₘOₙ (where M represents at least one element selected from the group consisting of Na, Mg, Sc, Y, Mn, Fe, Co, Ni, Cu, Zn, Al, Cr, Pb, Sb and B, and x, m and n satisfy 0≦x≦1.2, 0.9≦m≦1.0 and 2.0≦n≦2.3), can be manufactured as follows, for example. First, a composite metal hydroxide including a metal other than lithium is prepared by a coprecipitation method using an alkaline agent such as sodium hydroxide. Next, the composite metal hydroxide is subjected to a heat treatment, thereby obtaining a composite metal oxide. Then, a lithium compound such as lithium hydroxide is added to the composite metal oxide, and it is further subjected to a heat treatment. Thus, there is obtained a lithium-containing composite metal oxide. The positive electrode active material may be one of the active materials described above used alone, or two or more of them used in combination, as necessary.

For the purpose of reducing the oxidative degradation reaction of the electrolyte solution on the positive electrode active material under high voltages, particularly, a part of whole of the active material surface may be covered with a metal oxide, a hydroxide, a metal salt, etc.

The conductive agent may be any of those that are commonly used in the field of lithium secondary batteries. For example, it may be a graphite such as natural graphite and artificial graphite, a carbon black such as acetylene black, ketjen black, channel black, furnace black, lamp black and thermal black, or a conductive fiber such as carbon fiber or metal fiber. One of these conductive agents may be used alone, or two or more of them may be used in combination, as necessary.

The binder may be any of those that are commonly used in the field of lithium secondary batteries. For example, it may be polyvinylidenefluoride (PVDF), polytetrafluoroethylene (PTFE), polyethylene, polypropylene, acrylic rubber, polyvinylacetate, polyvinylpyrrolidone, polyether, polyethersulfone, hexafluoropolypropylene, styrene-butadiene rubber, modified acrylic rubber, carboxymethylcellulose, etc. One of these binders may be used alone, or two or more of them may be used in combination, as necessary.

The positive electrode active material layer 33 is formed as follows, for example. First, a positive electrode mixture slurry is prepared, which includes a positive electrode active material, and includes, as necessary, a conductive agent, a binder, etc., dissolved or dispersed in an organic solvent. Next, the positive electrode mixture slurry is applied on the surface of the positive electrode current collector, and dried. The organic solvent may be, for example, dimethylformamide, dimethylacetamide, methylformamide, n-methyl-2-pyrrolidone (NMP), dimethylamine, acetone, cyclohexanone, etc. The positive electrode mixture slurry can be prepared by using an ordinary mixer, a disperser, or the like, for mixing together powder and liquid.

The thickness of the positive electrode active material layer is suitably selected depending on various conditions such as the design performance, the application, etc., of the lithium secondary battery, and where the positive electrode active material layer is provided on both sides of the positive electrode current collector, it is preferred that the total thickness of the positive electrode active material layers formed on both sides is about 50 to 150 μm.

<Configuration and Production Method of Negative Electrode 20>

The negative electrode active material may be a carbon material, a metal oxide, or an alloy material of silicon, tin, etc., that is capable of absorbing/desorbing lithium.

The carbon material may be a known material such as graphite or hard carbon. Even when graphite is used for the negative electrode, the positive electrode is charged with a potential of 4.3 V or more in some cases.

A metal oxide may be lithium titanate. Since lithium titanate has a high operating potential of about 1.5 V with respect to lithium, it is preferable, for achieving a high capacity of the battery, to use it while increasing the potential of the positive electrode.

There is no particular limitation on the alloy material, and it may be any of those that are known in the art. It may be, for example, a silicon-containing compound—a tin-containing compound, etc. The silicon-containing compound may be, for example, silicon, a silicon oxide, a silicon nitride, a silicon-containing alloy, a silicon compound, a solid solution thereof, etc. The silicon oxide may be, for example, a silicon oxide that is represented by a composition formula: SiO_{α} (0≦α≦2), for example. The silicon carbide may be, for example, a silicon carbide that is represented by a composition formula: SiC (0<β<1). The silicon nitride may be, for example, a silicon nitride that is represented by a composition formula: SiN_{γ} (0<γ<4/3). The silicon-containing alloy may be, for example, an alloy including silicon, and one or two or more element selected from the group consisting of Fe, Co, Sb, Bi, Pb, Ni, Cu, Zn, Ge, In, Sn and Ti. A part of the silicon may be substituted with one or two or more element selected from the group consisting of B, Mg, Ni, Ti, Mo, Co, Ca, Cr, Cu, Fe, Mn, Nb, Ta, V, W, Zn, C, N and Sn. Among others, SiO_{α} (0≦α≦2), which has a desirable charging/discharging reversibility, may be used. The tin-containing compound may be, for example, tin, a tin oxide, a tin nitride, a tin-containing alloy, a tin compound, a solid solution thereof, etc. The tin-containing compound may be, for example, tin, a tin oxide such as SnO_{δ} (0<δ<2) or SnO₂, an Ni—Sn alloy, an Mg—Sn alloy, an Fe—Sn alloy, a Cu—Sn alloy, a tin-containing alloy such as a Ti—Sn alloy, a tin compound such as SnSiO₃, Ni₂Sn₄ and Mg₂Sn, etc. Where tin or a tin oxide such as SnO_{β} (0<β<2) or SnO₂ is used, among others, there is an advantage that it is possible to achieve a large capacity per weight, and it is also possible to realize a desirable charging/discharging reversibility.

The negative electrode current collector 21 may be, for example, a rolled foil, an electrolytic foil, or the like, made of copper or a copper alloy. There is no particular limitation on the shape of the negative electrode current collector 21, and it may be a perforated foil, an expanded material, a lath material, etc., as well as a foil. The tensile strength increases as the negative electrode current collector 21 is thicker, but if the negative electrode current collector 21 is too thick, the void volume inside the battery casing may decrease, thereby lowering the energy density. For the purpose of improving the adhesion with the mixture, the surface of the foil may be provided with projections, particles, etc.

Where a powder of the negative electrode active material is used, the negative electrode active material layer 23 is formed by a method as follows, for example, on one side or on both sides of the negative electrode current collector. First, a paste-like negative electrode mixture is produced, in which a negative electrode active material, a binder, and as necessary, a thickener and a conductive additive, are kneaded and dispersed in a solvent. Next, the negative electrode mixture is applied on the surface of the negative electrode current collector, and then dried, thereby obtaining the negative electrode active material layer 23. Then, the negative electrode current collector with the negative electrode active material layer formed thereon is rolled. Thus, the negative electrode 20 is obtained. The negative electrode 20 may be flexible.

The negative electrode active material layer 23 may be deposited directly on the negative electrode current collector 21 by a gas-phase process such as a vacuum deposition method, sputtering, a CVD method, etc. Since components such as a binder or a conductive agent are not substantially included, it is possible to increase the capacity, and it is easier to increase the bindability with the negative electrode current collector. Note that “components such as a binder or a conductive agent are not substantially included” includes cases where a binder or a conductive agent is included in members other than the negative electrode active material layer 23, and the negative electrode active material layer 23 therefore contains therein minute amounts of these substances, for example.

While there is no particular limitation on the form of the negative electrode active material layer 23, it may be an aggregate of a plurality of columnar assemblies (columnar active material assemblies). A plurality of columnar active material assemblies may be formed so as to extend in the same direction. Such a negative electrode active material layer can be manufactured by providing a plurality of protrusions on the surface of the negative electrode current collector 21, and forming a columnar active material assembly on each of these protrusions.

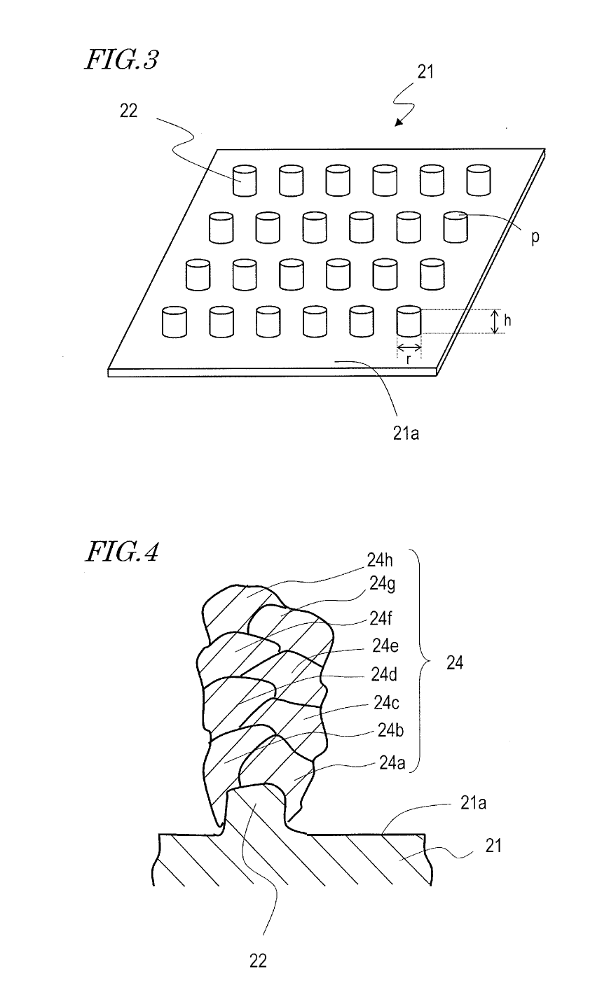

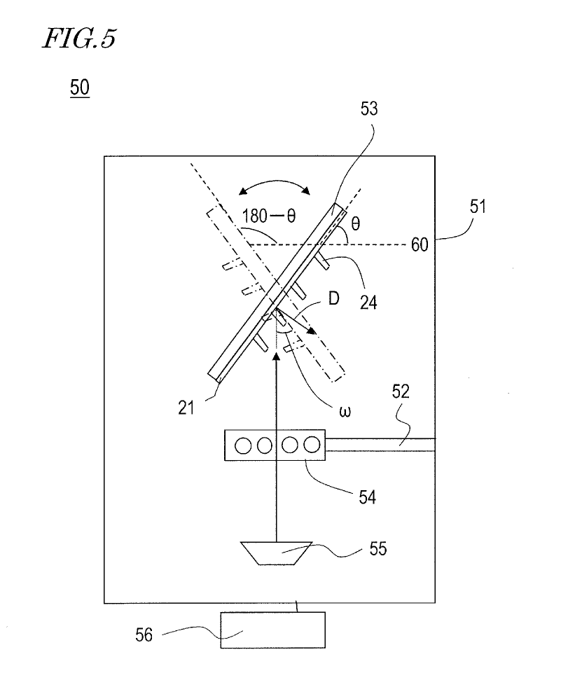

A more detailed configuration of the negative electrode 20 will now be described with reference to FIGS. 3 and 4. For the sake of simplicity, FIG. 4 only shows on columnar active material assembly. FIG. 3 is a schematic perspective view of the negative electrode current collector 21.

As shown in FIG. 3, the negative electrode current collector 21 includes a plurality of protrusions 22 on a surface (the surface on which the negative electrode active material layer 23 is to be formed) 21a. The protrusions 22 may be arranged randomly, or arranged regularly as shown in the figure. While there is no particular limitation on the height (average height) h of the protrusions 22, it may be 3 μm or more. On the other hand, the height h of the protrusions 22 may be 10 μm or less. While there is no particular limitation on the cross-sectional diameter r of the protrusions 22, it may be 1 μm or more and 50 μm or less, for example.

In the example shown in FIG. 3, the shape of the protrusion 22 as seen from the normal direction to the negative electrode 20 is circular. The shape of the protrusion 22 is not limited to a circle, but may be, for example, a polygon, an ellipse, a parallelogram, a trapezoid, a rhombus, etc. The protrusions 22 may be arrayed regularly at a predetermined arrangement pitch, or may be arrayed in a pattern such as a staggered lattice pattern, a grid pattern, etc., for example. The arrangement pitch of the protrusions 22 (the distance between the centers of adjacent protrusions 22) is, for example, 10 μm or more and 100 μm or less.

The negative electrode current collector 21 of the present embodiment can be produced by forming depressions/protrusions on a current collector material sheet such as a metal foil, a metal sheet, etc., for example. The method for forming depressions/protrusions may be a method of transferring the surface of a roller having a plurality of depressions formed on the surface thereof (hereinafter referred to as the “roller process method”), a photoresist method, etc.

In the roller process method, a current collector material sheet is mechanically pressed using a roller having depressions formed on the surface thereof (hereinafter referred to as the “protrusion forming roller”). Thus, it is possible to form a plurality of protrusions 22 on at least one surface of the current collector material sheet. The current collector material sheet may be a sheet including materials such as those described above as materials of the negative electrode current collector 21.

As shown in FIG. 4, the negative electrode active material layer 23 includes a plurality of columnar active material assemblies 24 extending from the surface of the protrusion 22 toward the outside of the negative electrode current collector 21. Each columnar active material assembly 24 may extend in the normal direction to the surface 21a of the negative electrode current collector 21. Alternatively, it may extend in a direction inclined with respect to the normal direction. Each columnar active material assembly 24 may have a structure in which a plurality of columnar masses of different growing directions are stacked together.

At least before being charged, each columnar active material assembly 24 preferably has a gap from an adjacent columnar active material assembly 24. This gap relaxes the stress from the expansion and shrinking during charging/discharging, thereby making it unlikely that the columnar active material assembly 24 comes off the protrusion 22. As a result, it is possible to suppress the deformation of the negative electrode current collector 21 or the negative electrode 20. As the columnar active material assemblies 24 are arranged, with gaps therebetween, on the surface of the negative electrode current collector 21, the transmission of the stress from the expansion and shrinking is more relaxed as compared with a case where the negative electrode active material layer 23 is formed in a film shape, thereby reducing cracks in the active material, which can trigger a side reaction with the electrolyte solution.

The negative electrode active material layer 23 including such columnar active material assemblies 24 is formed as follows. First, a columnar mass 24a is formed so as to cover a top portion of the protrusion 22 and a portion of the side surface continuous with the top portion. Next, a columnar mass 24b is formed so as to cover the rest of the side surface of the protrusion 22 and a portion of the top surface of the columnar mass 24a. That is, referring to the cross-sectional view shown in FIG. 4, the columnar mass 24a is formed on one end of the protrusion 22 including the top portion thereof, and although the columnar mass 24b partially overlaps with the columnar mass 24a, the rest of the columnar mass 24b is formed on the other end of the protrusion 22. Moreover, a columnar mass 24c is formed so as to cover the rest of the top surface of the columnar mass 24a and a portion of the top surface of the columnar mass 24b. That is, the columnar mass 24c is formed so as to be in contact primarily with the columnar mass 24a. Moreover, a columnar mass 24d is formed so as to be in contact primarily with the columnar mass 24b. Thereafter, columnar masses 24e, 24f, 24g and 24h are similarly stacked alternately, thereby forming the columnar active material assembly 24.

The columnar active material assembly 24 preferably has a structure in which n (n≧2) layers (columnar masses) are stacked together. It may be a columnar member including eight columnar masses 24a, 24b, 24c, 24d, 24e, 24f, 24g and 24h stacked together as shown in FIG. 4.

FIG. 5 is a cross-sectional view illustrating an electron beam-type vapor deposition apparatus 50 used to form the negative electrode active material layer 23. In FIG. 5, members inside the vapor deposition apparatus 50 are also indicated by solid lines.

The vapor deposition apparatus 50 includes a chamber 51, a first pipe 52, a holder 53, a nozzle 54, a target (evaporation source) 55, an electron beam generator (not shown), a power supply 56, and a second pipe (not shown). The chamber 51 is a pressure-resistant container-shaped member having a space therein, and the chamber 51 houses therein the first pipe 52, the holder 53, the nozzle 54 and the target 55. The first pipe 52 supplies a material gas to the nozzle 54. One end of the first pipe 52 is connected to the nozzle 54. The other end of the first pipe extends out of the chamber 51 and is connected to a material gas cylinder or a material gas manufacturing apparatus (not shown) via a mass flow controller (not shown). The material gas may be, for example, oxygen, nitrogen, etc.

The holder 53 is a plate-shaped member, and is supported so that the angle thereof can be changed or it can be rotated with respect to a horizontal plane 60. The negative electrode current collector 21 is secured on one surface of the holder 53. The position of the holder 53 is switched between the first position indicated by a solid line and the second position indicated by a one-dot-chain line in FIG. 5, for example, thus enabling the switching of the angle of vapor deposition.

The first position is such a position that the surface of the holder 53 on which the negative electrode current collector 21 is secured opposes the nozzle 54 vertically below it, and that the angle formed between the holder 53 and the horizontal plane 60 is α°. The second position is such a position that the surface of the holder 53 on which the negative electrode current collector 21 is secured opposes the nozzle 54 vertically below it, and that the angle formed between the holder 53 and the horizontal plane 60 is (180−α°). The angle α° is suitably selected depending on the size of the columnar active material assembly 24 to be formed, etc.

The nozzle 54 is provided between the holder 53 and the target 55 in the vertical direction. The nozzle 54 mixes together a vapor of an evaporation material such as an alloy-based active material which evaporates off the target 55 and goes up in the vertically upward direction, and the material gas supplied from the first pipe 52, and supplies the mixture onto the surface of the negative electrode current collector 21 secured on the surface of the holder 53.

The vapor deposition material is supplied while the negative electrode current collector 21 is secured on the holder 53, and the holder 53 is set in the first position and the second position. By repeating this eight times, the negative electrode active material layer 23 including a plurality of columnar active material assemblies 24 as shown in FIG. 4 is formed on the surface 21a of the negative electrode current collector 21.

Note that although the negative electrode active material layer 23 is formed by using oblique vapor deposition in the present embodiment, lift-off as described in Patent Document No. 2 may be used instead. Alternatively, a negative electrode active material layer having a columnar structure may be formed by depositing an active material film and then patterning the film.

<Separator>

The separator 13 may be a microporous film or a nonwoven fabric of a polyolefin resin such as a polyethylene resin, a polypropylene resin, etc. A microporous film or a nonwoven fabric may be a single layer, or may have a multi-layer structure. Preferably, a separator is used, which has a two-layer structure including a polyethylene resin layer and a polypropylene resin layer, or a three-layer structure including two polypropylene resin layers and a polyethylene resin layer arranged therebetween. These separators preferably have a shutdown function. The thickness of the separator 7 is preferably 10 μm or more and 30 μm or less, for example.

<Nonaqueous Electrolyte Solution>

The nonaqueous electrolyte solution includes a nonaqueous solvent, an electrolyte solution additive, a compound having an isocyanate group, lithium difluorophosphate, and an electrolyte. The nonaqueous solvent includes a carbonate other than fluoroethylene carbonate.

Specifically, the carbonate other than fluoroethylene carbonate includes ethylene carbonate, and at least one selected from the group consisting of propylene carbonate, dimethyl carbonate, diethyl carbonate and methyl ethyl carbonate. The amount added of the nonaqueous solvent accounts for the balance of the amount added of other compounds to be described below.

Specifically, the electrolyte solution additive is fluoroethylene carbonate (FEC). Fluoroethylene carbonate forms a coating on the negative electrode, thereby improving the charge-discharge cycle characteristic. In the nonaqueous electrolyte solution, fluoroethylene carbonate may be contained by 2 wt % or more and 20 wt % or less. Being 2 wt % or more gives an advantage of suppressing the degradation of the electrolyte solution on the negative electrode surface, and being 20 wt % or less gives an advantage of reducing the generation of the gas from the degradation of FEC.

A compound having an isocyanate group may be hexamethylene diisocyanate, diphenylmethane diisocyanate, dicyclohexylmethane diisocyanate, tert-butyl isocyanate, isopropyl isocyanate, butyl isocyanate, cyclohexyl isocyanate, octadecyl isocyanate, phenyl isocyanate, propyl isocyanate, fluorophenyl isocyanate, hexyl isocyanate, toluene diisocyanate, xylene diisocyanate, tolylene diisocyanate, etc. Particularly, where hexamethylene diisocyanate is used, there is an advantage of suppressing the elution of cobalt during storage at a high temperature. One of these compounds may be used alone, or two or more of them may be used in combination. The amount added of a compound having an isocyanate group may be 0.1 wt % or more and 5.0 wt % or less. If the nonaqueous electrolyte solution includes a compound having an isocyanate group in this range, the advantageous effects described above can be exerted without causing a substantial performance deterioration due to an increase in the reaction resistance.

The nonaqueous electrolyte solution may further include a compound including a nitrile group. A compound including a nitrile group may be adiponitrile, glutaronitrile, 2-methylglutaronitrile, 3-methoxypropionitrile, methyl cyanoacetate, sebaconitrile, and oxypropionitrile. Particularly, where adiponitrile is used, there is an advantage of suppressing the elution of cobalt during storage at a high temperature. One of these compounds may be used alone, or two or more of them may be used in combination. The amount added of a compound including a nitrile group may be 0.1 wt % or more and 5.0 wt % or less. If the nonaqueous electrolyte solution includes a compound including a nitrile group in this range, the advantageous effects described above can be exerted without causing a substantial performance deterioration due to an increase in the reaction resistance.

The amount added of lithium difluorophosphate may be 0.1 wt % or more and 1.0 wt % or less. If the nonaqueous electrolyte solution includes lithium difluorophosphate in this range, a protective layer having a smaller charge transfer resistance than those of conventional techniques is formed on the positive electrode surface, preferentially over other electrolyte solution components. Thus, it is possible to suppress the degradation reaction of the electrolyte, the solvent and the additive while improving the capacity and the output performance.

The electrolyte includes at least one selected from the group consisting of lithium hexafluorophosphate, lithium tetrafluoroborate, bistrifluoromethanesulfonylimide lithium, bis(perfluoroethyl sulfonyl)imide lithium and lithium bis(oxalato)borate. One of these electrolytes may be used alone, or two or more of them may be used in combination. These electrolytes may be dissolved in the nonaqueous solvent described above at a concentration of 0.5 M or more and 1.5 M or less.

The nonaqueous electrolyte solution may further include a polymer material. For example, a polymer material capable of gelating a liquid-form substance may be used. The polymer material may be any of those known in the art. For example, it may be polyvinylidene fluoride, polyacrylonitrile, polyethylene oxide, etc.

Various other additives may be included for the purpose of improving the cycle characteristic, suppressing overcharging, and improving the storage characteristic. While there is no particular limitation on these additives, these additives may be, for example, vinylene carbonate (VC), ethylene sulfite (ES), propanesultone (PS), cyclohexyl benzene (CHB), etc.

With the lithium secondary battery of the present embodiment, the nonaqueous electrolyte solution includes fluoroethylene carbonate, a carbonate other than fluoroethylene carbonate, a compound having an isocyanate group, and lithium difluorophosphate. Fluoroethylene carbonate has a high oxidation resistance, and is suitable as a nonaqueous solvent of a lithium secondary battery that is charged/discharged at a high voltage. However, in an electrolyte solution including an electrolyte, it may degrade at a high temperature to generate a gas. Since it has a weak reduction resistance, it may be reduced at the negative electrode, thereby producing a degradation product. This degradation product may be oxidized at the positive electrode to degrade.

A compound having an isocyanate group forms a coating on the positive electrode and the negative electrode to suppress the degradation of fluoroethylene carbonate, and suppresses the degradation of fluoroethylene carbonate in the electrolyte solution. Through the formation of a coating, it is possible to suppress the elution of cobalt from the positive electrode. This suppresses the disturbance in the surface structure of the positive electrode, and micro short-circuiting due to cobalt depositing on the negative electrode.

However, the compound having an isocyanate group is a consumed additive, and the compound itself degrades and is consumed, while it provides the advantageous effects described above. Therefore, as it is consumed, these advantageous effects are reduced, thus deteriorating the long-term battery characteristics of the lithium secondary battery.

Lithium difluorophosphate forms a protective layer at the positive electrode preferentially over the compound having an isocyanate group, thereby suppressing the consumption of the compound having an isocyanate group through degradation. The protective layer of lithium difluorophosphate to be formed has a lower resistance than the protective layer of the compound having an isocyanate group, thereby contributing to the increase in the initial capacity. As a result, it is possible to exert the advantageous effects described above of the compound having an isocyanate group over a long period of time, and suppress the long-term deterioration of the battery characteristics of the lithium secondary battery.

Thus, according to the present embodiment, it is possible to realize a lithium secondary battery having a large capacity and a long-term reliability, e.g., improving the restoration characteristic after storage at a high temperature and suppressing the battery swelling after storage at a high temperature. Such features provide desirable effects particularly with a lithium secondary battery that is charged with a potential of 4.3 V or more.

### EXAMPLES

### 1. Production of Lithium Secondary Battery

A lithium secondary battery described above in the first embodiment was produced.

(Production of Positive Electrode)

Two parts by weight of acetylene black (conductive agent), 3 parts by weight of polyvinylidene fluoride powder (binder), and an organic solvent (NMP) were sufficiently mixed together with 96 parts by weight of LiCoO₂ powder, thereby preparing a mixture paste. This mixture paste was applied on one side of an aluminum foil (positive electrode current collector) having a thickness of 15 μm, and it is then dried and rolled, thereby forming a working electrode having a thickness of 122 μm that is filled with the positive electrode active material at a density of 3.6 g/cm³. The positive electrode capacity per unit area was 3.6 mAh/cm² (a capacity as obtained in a capacity evaluation where a lithium metal is used as the counter electrode under the following conditions: the charging/discharging was constant current charging/discharging; the charging current value was 0.1 mA/cm²; the final voltage was 4.45 V; the discharging current value was 0.1 mA/cm²; and the final voltage was 3.0 V).

(Production of Negative Electrode)

A negative electrode active material layer was formed through a vapor deposition of a silicon oxide as a negative electrode active material on one side of a negative electrode current collector. The negative electrode current collector was an alloy copper foil with a plurality of protrusions whose maximum height Rz was about 8 μm formed on both sides.

A negative electrode current collector having depressions/protrusions on the surface thereof was produced by a roller process method. First, a ceramic layer having a thickness of 100 μm was formed by thermally spraying chromium oxide onto the surface of a cylinder-shaped iron roller (diameter: 50 mm). A plurality of depressions having a depth of 6 μm were formed on the surface of this ceramic layer by a laser process. Each depression had a circular shape having a diameter of 12 μm as seen from above the ceramic layer. At the bottom of each depression, the central portion is substantially flat, and the peripheral portion of the bottom portion has a rounded shape. The arrangement of these depressions was a most packed arrangement where the axis-to-axis distance between adjacent depressions was 20 μm. Thus, a protrusion forming roller was obtained. Next, an alloy copper foil (tradename: HCL-02Z, thickness: 26 μm, from Hitachi Cable, Ltd.) containing zirconia at a proportion of 0.03 wt % with respect to the total amount was heated for 30 minutes at a temperature of 600° C. in an argon gas atmosphere for annealing. This alloy copper foil was passed through the contact area, where two protrusion forming rollers are pressed against each other, under a linear pressure of 2 t/cm. Thus, both sides of the alloy copper foil were press-molded, thereby obtaining a negative electrode current collector having a plurality of protrusions on both sides. A cross section of the negative electrode current collector taken vertical to the surface thereof with a scanning electron microscope indicated that a plurality of protrusions whose average height was about 6 μm were formed on both sides of the negative electrode current collector. Then, copper particles were formed on the top surface of the protrusions by an electrolytic plating method. The surface roughness Ra was 2.0 μm.

Next, a negative electrode active material layer was formed by an oblique vapor deposition on the surface of the negative electrode current collector produced by the method described above. The electron beam-type vapor deposition apparatus 50 shown in FIG. 5 was used for the formation of the negative electrode active material layer.

First, the negative electrode current collector was secured on the holder 53 of the vapor deposition apparatus 50. The holder 53 was set so that it can be switched between the first position (the position indicated by a solid line in FIG. 4) at which the angle with respect to the horizontal plane is 60° (α=60°) and the second position (the position indicated by a one-dot-chain line in FIG. 5) at which the angle with respect to the horizontal plane is 120° (180−α=120°). Then, 35 iterations of a vapor deposition step were performed while alternating the position of the holder 53 between the first position and the second position. The specific vapor deposition conditions and materials were as shown below. The vapor deposition was done without introducing an oxygen gas. The degree of vacuum was set to 5×10⁻⁴ Pa. The oxygen gas amount was introduced for the formation of the negative electrode active material layer, and the amount was adjusted as necessary. The number of iterations of the vapor deposition step was set to 50.

Raw material of negative electrode active material (evaporation source):

Silicon (purity: 99.9999%, from Kojundo Chemical Lab. Co., Ltd.)

Oxygen discharged from oxygen nozzle 54 (purity: 99.7%, from Nihonsanso. Co., Ltd.)

Angle α of holder 53: 60°

Electron beam acceleration voltage: −8 kV

Emission: 500 mA

Vapor deposition time: 3 min×50 iterations

Thus, a negative electrode active material layer formed by a plurality of columnar active material assemblies was formed on one surface of the negative electrode current collector 21, thereby obtaining the negative electrode. A columnar active material assembly 24 was formed on each protrusion of the negative electrode current collector 21, with a structure including 50 columnar masses stacked together. It had grown in the direction in which the protrusion was extending from the top portion of the protrusion and the side surface in the vicinity of the top portion.

The amount of oxygen included in the columnar active material assembly 24 was quantified by a combustion method. As a result, for a negative electrode for evaluation, the average composition of the compound of the columnar active material assembly 24 was SiO0.25. Note that the degree of oxidation x refers to the molar ratio of the amount of oxygen with respect to the amount of silicon in the silicon oxide (SiOₓ). An analysis of the composition of the negative electrode active material layer showed that X=1.3 for a layer having a high degree of oxidation in the vicinity of the interface between the Cu substrate and the negative electrode active material. The composition was given a gradient so that the degree of oxidation gradually decreases over a region of about 0 to 3 μm from the Cu interface toward the surface, and the degree of oxidation was X=0.1 in the region of about 3 to 14 μm. The weight of silicon per unit area was 2.0 mg/cm².

Then, a negative electrode produced by the method described above was subjected to preliminary lithium absorption. This is for compensating for the irreversible capacity of the negative electrode active material in advance, while adjusting the potential region over which the negative electrode active material is to be used. A lithium metal corresponding to 1.5 mAh/cm² was vapor-deposited on the negative electrode surface. The preliminary absorption method will now be described in greater detail.

First, a lithium metal was loaded in a tantalum boat in the chamber of a resistance heating vapor deposition apparatus (from ULVAC). Next, a negative electrode for evaluation was secured so that the negative electrode active material layer formed on one side of the negative electrode faces the tantalum boat. Then, in an argon atmosphere, a current of 50 A was conducted through the tantalum boat so as to subject the negative electrode active material layer of the negative electrode for evaluation to a 10-minute vapor deposition, thereby vapor-depositing a lithium metal.

After the vapor deposition of the metal lithium, the discharge capacity of the negative electrode was 6.2 mAh/cm² (a capacity as obtained in a capacity evaluation where a lithium metal was used as the counter electrode under the following conditions: the charging/discharging was constant current charging/discharging; the charging current value was 0.1 mA/cm²; the final voltage was 0 V; the discharging current value was 0.1 mA/cm²; and the final voltage was 1.5 V was obtained as the counter electrode capacity).

(Preparation of Electrolyte Solution)

A method for producing an electrolyte solution will be described.

Ethylene carbonate (from Mitsubishi Chemical Corporation; hereinafter abbreviated as EC) was heated to 45° C. and dissolved, and propylene carbonate (from Mitsubishi Chemical Corporation; hereinafter abbreviated as PC) and diethyl carbonate (from Mitsubishi Chemical Corporation; hereinafter abbreviated as DEC) were mixed therein at a weight ratio of 10:50:40. Moreover, LiPF₆ (from Stella Chemifa Corporation) was dissolved at a molarity of 1.2 mol/L (base electrolyte solution).

To the base electrolyte solution, 6 wt % of fluoroethylene carbonate (hereinafter abbreviated as FEC), 1 wt % of hexamethylene diisocyanate (hereinafter abbreviated as HMDI) and 0.5 wt % of lithium difluorophosphate were added (Electrolyte Solution A).

To the base electrolyte solution, 10 wt % or FEC, 1 wt % of HMDI, 0.5 wt % of lithium difluorophosphate, 0.5 wt % of adiponitrile (hereinafter abbreviated as AdpCN) were added (Electrolyte Solution B).

To the base electrolyte solution, 6 wt % or FEC, 1 wt % of HMDI and 0.25 wt % of lithium difluorophosphate were added (Electrolyte Solution C).

To the base electrolyte solution, 6 wt % of FEC was added (Electrolyte Solution D).

To the base electrolyte solution, 6 wt % of FEC and 0.5 wt % of HMDI were added (Electrolyte Solution E).

To the base electrolyte solution, 6 wt % of FEC and 1 wt % of HMDI were added (Electrolyte Solution F).

To the base electrolyte solution, 10 wt % of FEC, 0.5 wt % of HMDI and 0.5 wt % of AdpCN were added (Electrolyte Solution G).

Table 1 shows the composition of Electrolyte Solutions A to G, other than the base electrolyte solution component.

(Assembly of Lithium Secondary Battery)

The positive electrode and the negative electrode were each cut into a strip shape of a predetermined length so that a 61 mm×700 mm positive electrode active material layer (area: 432 cm²) opposes a 62.5 mm×720 mm negative electrode active material layer, while providing each electrode with a current collector portion where the active material layer is absent, and a lead was welded to the current collector portion. The positive electrode was provided with a portion where the positive electrode current collector was exposed, and one end of an aluminum-made positive electrode lead was connected to that portion. The negative electrode was provided with a portion where the negative electrode current collector was exposed, and one end of a nickel-made negative electrode lead was connected to that portion. They were rolled up with a separator of a polyethylene microporous film interposed between the positive electrode and the negative electrode, thereby producing a group of electrodes. This group of electrodes was inserted into an external casing made of an aluminum laminate. After the other end of the positive electrode lead and the other end of the negative electrode lead were drawn out of the battery casing, with the inside of the battery casing depressurized, 3.0 g of Electrolyte Solution A-G was poured while depressurizing the inside of the external casing. The opening of the external casing was welded shut, thus obtaining a lithium secondary battery having a design capacity of 1425 mAh. Lithium secondary batteries including Electrolyte Solutions A to G were labeled Examples 1-3 and Reference Examples 1-4, respectively.

### 2. Evaluation of Lithium Secondary Battery

A charging/discharging test was conducted under the following conditions.

(Charging/Discharging Conditions)

Charge 1: Constant current charging, 140 mA, 4.3 V

Discharge 1: Constant current charging, 280 mA, 3.0 V cut

Charge 2: Constant current constant voltage charging, 280 mA, 4.3 V-70 mA cut

Discharge 2: Constant current charging, 280 mA, 3.0 V cut

Charge 3: Constant current constant voltage charging, 280 mA, 4.3 V-70 mA cut

Temperature: 25° C.

In order to vent the gas produced while charging/discharging, the laminate film of the battery having undergone Charge 1 and Discharge 1 was partially opened, and then was depressurized again and sealed. Then, Charge 2 and Discharge 2 were performed to determine the capacity of Discharge 2 as the initial capacity (mAh). Then, Charge 3 was performed, and the AC impedance was measured under predetermined conditions, after which it was stored for 20 days under an atmosphere at 60° C.

(Evaluation)

After storage, the thickness of the battery was measured to determine, as the battery swelling, the difference between the measured thickness and the thickness before storage. Next, it was charged/discharged through Discharge 2-Charge-Discharge 2 under the charging/discharging conditions described above to evaluate the post-storage restoration rate as (discharge capacity during second discharge after storage)/(discharge capacity before storage). The micro short-circuit was judged from the disturbance in the shape of the charging curve during the first charge after storage. These results are shown in Table 2.

(Measurement of AC Impedance)

For Example 1 and Reference Examples 1 and 3, the AC impedance Cole-Cole plot in the initial charged state of the lithium secondary battery was produced to obtain the charge transfer resistance of the positive electrode. The measurement conditions were as follows.

AC impedance measurement conditions:

Frequency: 1 MHz to 0.05 Hz, Amplitude: 10 mV, Temperature: 25° C.

### 3. Results and Discussion

TABLE 1

| | | | Lithium difluoro- | |
|---|---|---|---|---|
| Electrolyte | FEC | HMDI | phosphate | AdpCN |
| A (Example 1) | 6 | 1 | 0.5 | |
| B (Example 2) | 10 | 1 | 0.5 | 0.5 |
| C (Example 3) | 6 | 1 | 0.25 | |
| D (Reference 1) | 6 | | | |
| E (Reference 2) | 6 | 0.5 | | |
| F (Reference 3) | 6 | 1 | | |
| G (Reference 4) | 10 | 0.5 | | 0.5 |

TABLE 2

| | | | | Post- | |
|---|---|---|---|---|---|
| | | Initial | Battery | storage | Micro |
| | | capacity | swelling | restoration | short- |
| | Electrolyte | (mAh) | (mm) | rate (%) | circuit |
| Example 1 | Electrolyte A | 1429 | 0.61 | 80 | None |
| Example 2 | Electrolyte B | 1432 | 0.94 | 78 | None |
| Example 3 | Electrolyte C | 1427 | 0.75 | 75 | None |
| Reference 1 | Electrolyte D | 1424 | 2.21 | 62 | Observed |
| Reference 2 | Electrolyte E | 1415 | 1.65 | 79 | None |
| Reference 3 | Electrolyte F | 1410 | 1.36 | 81 | None |
| Reference 4 | Electrolyte G | 1399 | 2.05 | 78 | None |

As indicated in Reference Examples 1 to 3 of Table 2, in a battery of which the base electrolyte solution includes FEC, if HMDI is added, the battery swelling during storage is suppressed according to the amount thereof added. However, a decrease in the initial capacity is observed. In contrast, as indicated in Example 1, if lithium difluorophosphate is further added, the initial capacity increased as compared with a case where only HMDI was added (Reference Examples 2 and 3) and a case where HMDI was not added (Reference Example 1). The battery swelling during storage was further reduced from a case where HMDI was added (Reference Examples 2 and 3). It is believed that this is because lithium difluorophosphate forms, preferentially over HMDI, a lower-resistance protective layer on the positive electrode.

A comparison between Examples 1 and 3 indicates that these advantageous effects depend on the amount of lithium difluorophosphate added, and that these advantageous effects can be increased if the amount added is increased.

Moreover, a comparison between Example 2 and Reference Example 3 indicates that where AdpCN was added in addition to lithium difluorophosphate, even if FEC was increased to 10 wt %, the capacity was higher and the battery swelling was smaller than in a case where FEC was 6%

### Reference Example 3

These results show that with a high voltage-type lithium secondary battery including FEC, by adding HMDI and lithium difluorophosphate, it is possible to increase the initial capacity and also to suppress the reductive degradation of FEC at the negative electrode.

In Examples 1 to 3, the post-storage capacity restoration rate after a 20-day storage at 60° C. is improved as compared with Reference Example 1. It can be seen from Examples 1 to 3 and Reference Examples 1 to 4 that with a high voltage-type lithium secondary battery including FEC, it is possible to suppress the micro short-circuit by adding HMDI. Based on the results of Reference Examples 2 and 3, it is believed that the post-storage restoration rate depends on the amount of HMDI added, and a coating formed by HMDI is gradually consumed over the course of charging/discharging and storage at a high temperature. It is believed that lithium difluorophosphate minimizes the HMDI consumption, and sustains, over a long period of time, the HMDI's effect of stabilizing the electrolyte solution including FEC therein. Thus, it is believed that it is possible to further enhance the advantageous effects of HMDI, i.e., the effect of preventing the occurrence of micro short-circuit, the effect of suppressing the generation of acid (HF) generated from FEC, LiPF₆, etc., the effect of suppressing the degradation of the electrolyte solution component on the positive electrode surface, and the effect of suppressing the battery swelling due to the degradation gas and the elution of cobalt from the positive electrode. It is also believed that the elution of cobalt and the deposition of cobalt on the negative electrode during storage at a high temperature are suppressed.

Table 3 shows the charge transfer resistance of the positive electrode for Example 1 and Reference Examples 1 and 3.

TABLE 3

| | Charge transfer re- |
|---|---|
| Sample | sistance (mΩ) |
| Example 1 | 14 |
| Reference 1 | 16 |
| Reference 3 | 31 |

As seen from Reference Examples 1 and 3, with a battery of which the base electrolyte solution includes FEC, if HMDI is added, the charge transfer resistance of the positive electrode increases. However, as indicated in Example 1, it can be seen that if lithium difluorophosphate is further added, the charge transfer resistance decreases as compared with a case where HMDI is not added. It is believed that this is because lithium difluorophosphate forms, preferentially over HMDI, a protective layer on the positive electrode, and the resistance thereof is smaller than that of a coating of HMDI.

As seen from such a charge transfer resistance trend of the positive electrode, Reference Example 3 including HMDI has an increased polarization for both charging and discharging as compared with Reference Example 1, which does not include HMDI. In contrast, Example 1 further including lithium difluorophosphate has a reduced polarization, which is smaller than that of Reference Example 1.

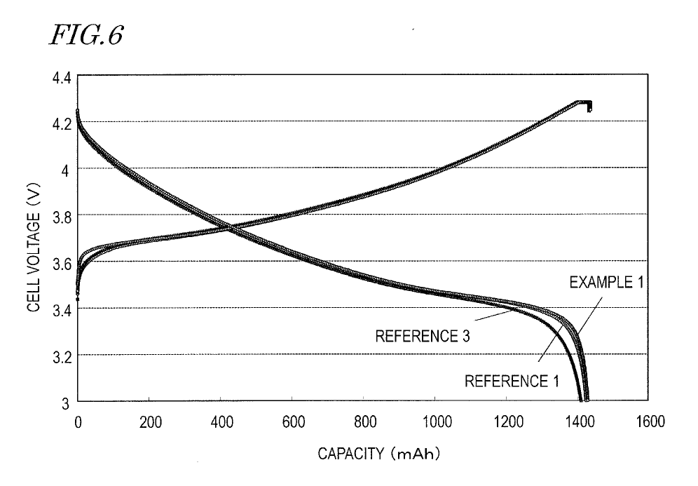

FIG. 6 shows the initial charging/discharging curve ((Charge 2, Discharge 2) for Example 1 and Reference Examples 1 and 3.

As described above, as a result of the increase/decrease of polarization, Reference Example 3 has a decreased positive electrode discharge capacity and a lowered battery capacity as compared with Reference Example 1. On the other hand, it can be seen that Example 1 has an increased positive electrode discharge capacity and an increased battery discharge capacity. It can be seen that it is possible to increase the discharge capacity by adding lithium difluorophosphate in Example 1 as compared with Reference Example 1, in which HMDI is not added.

### INDUSTRIAL APPLICABILITY

The lithium secondary battery disclosed in the present application can be used in similar applications to those of conventional lithium secondary batteries, and particularly, it can be used as a power supply for a portable electronic device, such as a personal computer, a mobile telephone, a mobile device, a personal digital assistant (PDA), a portable game device, a video camera, etc. It can also be expected to be used as a secondary battery assisting an electric motor in a hybrid electric vehicle, a fuel cell vehicle, etc., as a power supply for driving an electric tool, a vacuum cleaner, a robot, etc., and as a power source for a plug-in HEV.

### REFERENCE SIGNS LIST

100 cell for evaluation
13 separator
16 gasket
17 external casing
18 positive electrode lead
19 negative electrode lead
20 negative electrode
21 negative electrode current collector
22 protrusion
23 negative electrode active material layer
24 columnar active material assembly
30 positive electrode
31 positive electrode current collector
33 positive electrode active material layer
40 lithium secondary battery
41 positive electrode lead
42 negative electrode lead
43 aluminum laminate external material
44 group of electrodes
50 electron beam-type vapor deposition apparatus
51 chamber
52 first pipe
53 holder
54 nozzle
55 target
56 power supply

1. A lithium secondary battery comprising:
a positive electrode including LiₓCoₘM₁₋ₘOₙ (M represents at least one element selected from the group consisting of Na, Mg, Sc, Y, Mn, Fe, Co, Ni, Cu, Zn, Al, Cr, Pb, Sb and B, where 0≦x≦1.2, 0.9≦m≦1.0, 2.0≦n≦2.3);
a negative electrode capable of absorbing/desorbing lithium;
a separator arranged between the positive electrode and the negative electrode; and
a nonaqueous electrolyte solution including fluoroethylene carbonate, a carbonate other than fluoroethylene carbonate, a compound having an isocyanate group, and lithium difluorophosphate, and a compound including 0.1 wt % or more and 5.0 wt % or less of a nitrile group.

2. The lithium secondary battery of claim 1, wherein the positive electrode is charged with a potential of 4.3 V or more with respect to metal lithium.

3. The lithium secondary battery of claim 1, wherein the nonaqueous electrolyte solution includes:
ethylene carbonate;
at least one selected from the group consisting of propylene carbonate, dimethyl carbonate, diethyl carbonate and methyl ethyl carbonate; and
at least one selected from the group consisting of lithium hexafluorophosphate, lithium tetrafluoroborate, bistrifluoromethanesulfonylimide lithium, bis(perfluoroethyl sulfonyl)imide lithium and lithium bis(oxalato)borate.

4. The lithium secondary battery of claim 1, wherein the compound having an isocyanate group is hexamethylene diisocyanate.

5. (canceled)

6. The lithium secondary battery of claim 1, wherein the compound having a nitrile group is adiponitrile.

7. The lithium secondary battery of claim 1, wherein the negative electrode includes at least one of silicon and a silicon alloy.

8. The lithium secondary battery of claim 7, wherein the silicon and the silicon alloy comprise a silicon oxide represented as SiO_{α} (0<α<2.0).

9. The lithium secondary battery of claim 1, wherein:
the negative electrode has a negative electrode current collector, and a negative electrode active material layer formed on the negative electrode current collector;
the negative electrode active material layer includes a plurality of active material assemblies arranged on a surface of the negative electrode current collector;
each of the plurality of active material assemblies has a plurality of layers stacked together; and
directions in which the plurality of layers grow are alternately inclined in opposite directions with respect to a normal direction to the negative electrode current collector.

10. The lithium secondary battery of claim 1, wherein the negative electrode does not substantially include a binder and a conductive agent.

11. A lithium secondary battery comprising:
a positive electrode including lithium cobalt oxide charged with a potential of 4.3 V or more with respect to metal lithium;
a negative electrode including silicon and/or a silicon alloy and being capable of absorbing/desorbing lithium;
a separator interposed between the positive electrode and the negative electrode; and
a nonaqueous electrolyte solution including fluoroethylene carbonate, hexamethylene diisocyanate lithium difluorophosphate, and a compound including 0.1 wt % or more and 5.0 wt % or less of a nitrile group.
